(19) United States
(12) Patent Application Publication
(10) Pub. No.: US 2004/0251879 A1
(43) Pub. Date: Dec. 16, 2004

(54) Battery charging system

(76) Inventor: Joseph Patino, Pembroke Pines, FL (US)

Correspondence Address: Larry G. Brown, Motorola, Inc., Law Department, 8000 West Sunrise Boulevard, Fort Lauderdale, FL, 33322, US

(21) Appl. No.: 10/459,271

(22) Filed: Jun. 11, 2003

(51) Int. Cl. H02J 7/00; H02J 7/04

(52) U.S. Cl. 320/150

(57) ABSTRACT

A system (100) and method for charging a battery. The battery charging system (100) includes a battery charger (110) and a battery (112). The battery (112) includes a thermistor (130) and a memory device (132) in which the thermistor (130) and the memory device (132) terminate in a single battery contact (128), and the battery charger (110) has a contact (126) for receiving the battery contact (128). In addition, the battery charger (110) selectively reads at least one of the memory device (132) and a value of the thermistor (130) through the battery charger contact (126). The battery charger (110) can include a voltage shifting element (158) and a microprocessor (144) for selectively reading the memory device (132) and the value of the thermistor (130). The battery charger (110) can further include a switch (162), and the microprocessor (144) can be programmed to selectively operate the switch (162).

### CROSS REFERENCE TO RELATED APPLICATIONS

(Not Applicable)

### BACKGROUND

1. Technical Field

This invention relates in general to charging systems and more particularly, to battery charging systems that identify battery information.

2. Description of the Related Art

Many rechargeable batteries include a memory device, such as an erasable programmable read only memory (EPROM), which contains important information about the battery in which it is embedded. For example, the information that the EPROM contains can include the battery type, such as whether the battery is a nickel-cadmium battery or a lithium battery, and specifics concerning the charging regime to be employed. Moreover, the EPROM can store “fuel gauge” information, which can enable the host device (the device to which the battery supplies power) or charger to determine accurately the state of charge of the battery based on measured battery voltage.

In addition to a memory device, many rechargeable batteries contain a thermistor. Incorporating a thermistor into a rechargeable battery permits a microprocessor in the battery charger to monitor the temperature of the battery during the charging process.

Batteries that contain a memory device and a thermistor must include separate contacts for each of these components. This configuration increases the number of contacts that the battery, the host device and the charger must carry for proper operation. An increased number of contacts, however, adds to the expense and the physical dimensions of the battery as well as the host device and the battery charger.

### SUMMARY OF THE INVENTION

The present invention concerns a battery charging system. The battery charging system includes a battery charger and a battery. The battery includes a thermistor and a memory device in which the thermistor and the memory device terminate in a single battery contact, and the battery charger has a contact for receiving the battery contact. In addition, the battery charger selectively reads at least one of the memory device and a value of the thermistor through the battery charger contact.

In one arrangement, the battery charger can be a stand-alone charger or a host device. Moreover, the thermistor and the memory device can be coupled in a parallel configuration. In another arrangement, the battery can further include a first voltage shifting element for maintaining a predetermined minimum voltage for the memory device. The memory device can be an erasable programmable read only memory. Also, the battery charger can include a second voltage shifting element and a microprocessor for selectively reading the memory device and the value of the thermistor. As an example, the second voltage shifting element can be a zener diode.

In one embodiment, the battery charger can include a switch, and the microprocessor can be programmed to selectively operate the switch. The battery charger contact can be coupled to the microprocessor through a first node, and the switch can be coupled to the first node. As an example, when the battery charger contact receives the battery contact, the microprocessor can deactivate the switch to read the value of the thermistor. As another example, when the battery charger contact receives the battery contact, the microprocessor can selectively activate and deactivate the switch to read the memory device.

In another aspect of the invention, the microprocessor can include an analog-to-digital converter coupled to the first node and an output coupled to the switch. Further, the microprocessor can include a current control circuit for controlling the flow of current to the battery, and the microprocessor can be coupled to the current control circuit.

The present invention also concerns a battery. The battery includes a thermistor and a memory device in which the thermistor and the memory device terminate in a single battery contact. The battery can further include a voltage shifting element for maintaining a predetermined minimum voltage for the memory device. In one arrangement, the thermistor, the voltage shifting element and the memory device are coupled in a parallel configuration.

The present invention also concerns a battery charger. The battery charger includes a contact and a microprocessor in which the microprocessor selectively reads both a memory device and a value of a thermistor through the contact. The battery charger can further include a voltage shifting element coupled to the contact, and the microprocessor can have an analog-to-digital converter coupled to the voltage shifting element. In another arrangement, the battery charger can also have a switch. The microprocessor can be programmed to selectively operate the switch to permit the microprocessor to read at least one of the memory device and the value of the thermistor.

The present invention also concerns a method for charging a battery. The method includes the steps of, in a battery charger having a first contact, coupling a second contact to the first contact in which a thermistor and a memory device terminate in the second contact and selectively reading at least one of the memory device and a value of the thermistor through the first contact and the second contact. The method can also include the steps of shifting a voltage to maintain a predetermined minimum voltage for the memory device and selectively operating a switch to permit the execution of the reading step.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a battery charging system in accordance with the inventive arrangements.

FIG. 2 illustrates another battery charging system in accordance with the inventive arrangements.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

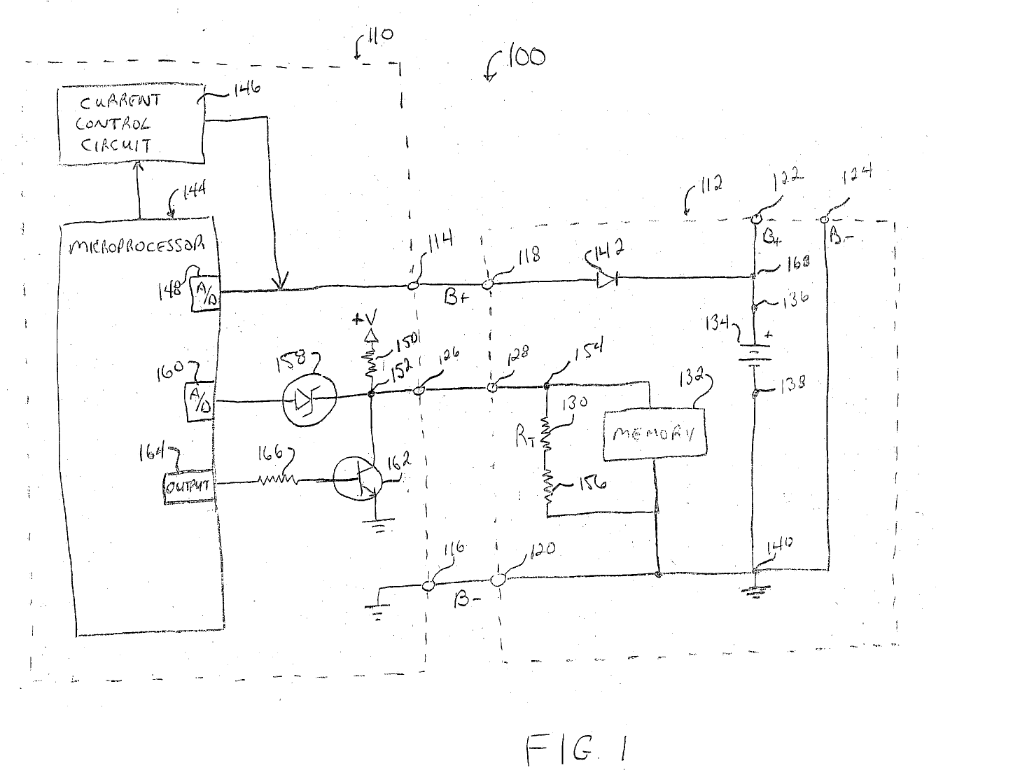

Referring to FIG. 1, a battery charging system 100 is illustrated. The battery charging system 100 can include a battery charger 110 and a battery 112. In one arrangement, the battery charger 110 can be a stand-alone charger or a host device. For example, a stand-alone charger can be a charger that receives power from a power supply and converts the power to a suitable level for charging a battery; typically, a stand-alone charger performs no other significant function. In contrast, a host device can be any component that can not only charge a battery but can also perform other important functions. Suitable examples of a host device include a computer or a radio.

In one embodiment, the battery charger 110 can detachably engage the battery 112 for purposes of charging the battery 112. Specifically, the battery charger 110 can include a positive battery charger contact 114, which can receive a positive battery contact 118, and a negative battery charger contact 116, which can receive a negative battery contact 120. The battery 112 can also include another positive battery contact 122 for providing a positive voltage (B+) to a host device (not shown) and another negative battery contact-124 for providing a ground voltage (B−) to the host device. Alternatively, a host device could attach directly to the positive battery contact 1118 and the negative battery contact 120. As will be discussed in detail below, the battery charger 110 can include a battery charger contact 126 for receiving a battery contact 128, into which a thermistor 130 and a memory device 132 may terminate.

The battery 112 can include one or more cells 134, which discharge to provide power to the host device. The battery charger 110 can recharge the cells 134 when the cells 134 become depleted. Further, the cells 134 can have a positive terminal 136 coupled to the positive battery contact 122 for providing the positive voltage B+ to the host device through a node 168. In addition, the cells 134 can include a negative terminal 138, which can be coupled to the negative battery contact 120 and the negative battery contact 124 through a node 140.

In another arrangement, the battery 112 can also include a diode 142, which can isolate the cells 134 from the battery charger 110. For example, the cathode of the diode 142 can be coupled to the positive terminal 136 through the node 168, and the anode of the diode 142 can be coupled to the positive battery contact 118. As noted earlier, when the battery 112 is detachably engaged to the battery charger 110, the positive battery charger contact 114 can receive the positive battery contact 118, through which current can flow from the battery charger 110.

The battery charger 110 can have a microprocessor 144 and a current control circuit 146. The current control circuit 146 can provide a variable current to the battery 112 based on control information provided by the microprocessor 144. Examples of such control information will be explained later. Additionally, the positive battery charger contact 114 can be coupled to the microprocessor 144 through an analog-to-digital (A/D) converter 148.

As noted earlier, the battery 112 can include a thermistor 130 and a memory device 132 in which the thermistor 130 and the memory device 132 terminate in a single battery contact, such as the battery contact 128. As an example, the thermistor 130 and the memory device 132 can be coupled in a parallel configuration. In one arrangement, the battery charger 110 can selectively read the memory device 132 or a value of the thermistor 130 through the battery charger contact 126 (when it receives the battery contact 128). For example, this value can be an impedance of the thermistor 130, which the microprocessor 144 of the battery charger 110 can use to monitor the temperature of the battery 112 as it is being charged.

As another example, the memory device 132 can be an EPROM that can store information about the battery 112, such as the battery type, the charging scheme to be employed and the status of the charge of the battery 112. The microprocessor 144 of the battery charger 110 can read the memory device 132, e.g., the EPROM, and can use this information for purposes of ensuring that the battery 112 is efficiently and properly charged.

The battery charger 110 can include a pull-up resistor 150 that can be coupled to a positive voltage (+V) and a node 152. The node 152 can be coupled to a node 154 in the battery 112 when the battery charger contact 126 receives the battery contact 128. As also shown in FIG. 1, the thermistor 130 and the memory device 132 can be coupled to the node 154. In one arrangement, a first voltage shifting element 156 can be coupled to the thermistor 130 and in parallel with the memory device 132. The pull-up resistor 150, the thermistor 130 and the first voltage shifting element 156 can create a voltage divider network, which can assist in determining the impedance of the thermistor 130. To ensure a minimal effect on the impedance readings of the thermistor 130, the memory device 132 can be designed to have a high impedance.

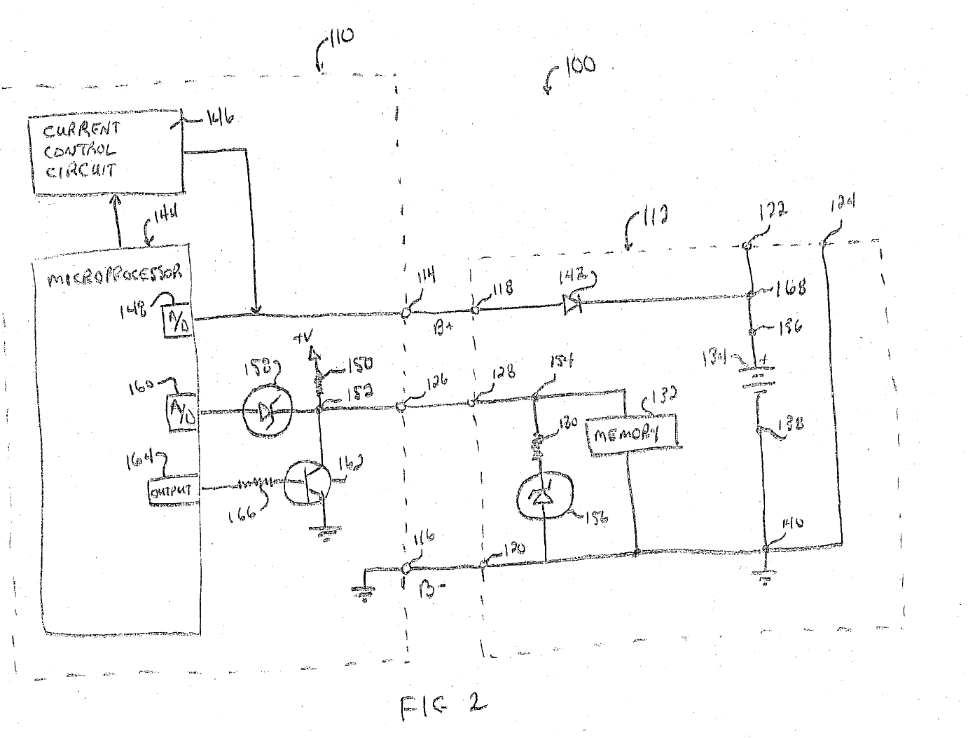

Although FIG. 1 shows the first voltage shifting element 156 as a resistor, it must be noted that the invention is in no way limited to this particular example. Referring to FIG. 2, the first voltage shifting element 156 can also be a zener diode in which the cathode of the zener diode is coupled to the thermistor 130. In this example, the pull-up resistor 150, the thermistor 130 and the zener diode, i.e., the first voltage shifting element 156, can form a voltage divider network.

Referring now to FIGS. 1 and 2, the battery charger 110 can include a second voltage shifting element 158. The second voltage shifting element 158 can be coupled to the node 152 and an A/D converter 160 of the microprocessor 144. The battery charger contact 126 can be coupled to the A/D converter 160 of the microprocessor 144 through the node 152 and the second voltage shifting element 158. As those of ordinary skill in the art will appreciate, the second voltage shifting element 158 can be used to shift the voltage at the node 152 to an acceptable input voltage level for the A/D converter 160. The second voltage shifting element 158 can be a zener diode; however, any suitable element that can shift voltage to protect the microprocessor 144 can serve as the second voltage shifting element 158.

In another arrangement, the microprocessor 144 can further include a switch 162. As an example, the switch 162 can be a transistor in which the collector of the transistor is coupled to the node 152, and its base can be coupled to an output 164 of the microprocessor 144 through a biasing resistor 166. The microprocessor 144 can be programmed to selectively operate the switch 162 to permit the microprocessor 144 to read a value of the thermistor 130 and the memory device 132.

In particular, to read a value of the thermistor 130, such as the impedance of the thermistor 130, the microprocessor 144 can deactivate or turn off the switch 162. The microprocessor 144 can deactivate the switch 162 by pulling the voltage low at the output 164. The voltage sensed by the A/D converter 160 is known in addition to the reference voltage of the second voltage shifting element 158. Thus, the voltage at the memory device 132 can be determined by adding the voltage at the A/D converter 160 and the reference voltage of the second voltage shifting element 158. That is:

V_{MD}=V_{A/D}+V_{SVSE}

where V_{A/D} is the voltage at the A/D converter 160; and

V_{SVSE} is the reference voltage of the second voltage shifting element 158, which is known.

The voltage at the memory device 132, which was determined above and is now known, is based on multiplying the positive voltage +V by the voltage divider network created by the pull-up resistor 150, the thermistor 130 and the first voltage shifting element 156. That is, the voltage at the memory device 132 is based on the following equation:

V_{MD}=(+V)×(R_{T}+R_{FVSE})/(R_{PU}+R_{T}+R_{FVSE})

where V_{MD} is the voltage at the memory device 132;

+V is the positive voltage;

R_{T} is the impedance of the thermistor 130;

R_{FVSE} is the impedance of the first voltage shifting element 156; and

R_{PU} is the impedance of the pull-up resistor 150.

Because V_{MD} is known (RT is the only unknown variable), those of ordinary skill in the art will appreciate that the microprocessor 144 can be programmed to determine the impedance of the thermistor 130 through manipulation of the above formula and the known variables. Because the impedance of the thermistor 130 can vary based on temperature, the microprocessor 144 can also be programmed to determine the temperature of the battery 112 once the impedance of the thermistor 130 is known.

In this example, the positive voltage +V can be any value suitable for meeting the voltage requirements of the memory device 132. Additionally, in view of the varying impedance of the thermistor 130, the first voltage shifting element 156 can ensure that a predetermined minimum voltage is maintained for the memory device 132. Those of ordinary skill in the art will also appreciate that the second voltage shifting element 158 can improve the resolution of the impedance reading of the thermistor 130.

Referring to FIG. 2, the impedance of the thermistor 130 can also be determined in a similar manner. In this example, the first voltage shifting element 156 can be a zener diode. The voltage that the A/D converter 160 of the microprocessor 144 senses is based on the following: (1) the difference between the positive voltage +V and the reference voltage of the first voltage shifting element 156 multiplied by the voltage divider created by the pull-up resistor 150 and the thermistor 130; and (2) the reference voltage of the first voltage shifting element 156 and the second voltage shifting element 158 respectively added to and subtracted from the value of step (1). That is, the voltage that the A/D converter 160 senses is based on the following formula:

V_{A/D}=[(R_{T}/R_{T}+R_{PU})×(+V−V_{FVSE})]+V_{FVSE}−V_{SVSE}

where V_{A/D} is the voltage at the A/D converter 160;

R_{T} is the impedance of the thermistor 130;

R_{PU} is the impedance of the pull-up resistor 150;

+V is the positive voltage;

V_{FVSE} is the reference voltage of the first voltage shifting element 156; and

V_{SVSE} is the reference voltage of the second voltage shifting element 158.

Similar to the process described above in relation to FIG. 1, the microprocessor 144 can determine the impedance of the thermistor 130 (the only unknown variable) through the manipulation of this formula. In one arrangement, the reference voltage of the first voltage shifting element 156 and the reference voltage of the second voltage shifting element 158 can be equal, which can cause these values to cancel each other out in the formula listed above. As noted earlier, once the impedance of the thermistor 130 is known, the microprocessor 144 can determine the temperature of the battery 112.

Referring to FIGS. 1 and 2, the microprocessor 144 can also read the memory device 132 through the battery charger contact 126 when the battery charger contact 126 receives the battery contact 128. As an example, the microprocessor 144 can read the memory device 132 through the A/D converter 160. In one arrangement, the microprocessor 144 can selectively activate, i.e., turn on, and deactivate, i.e., turn off, the switch 162 to read the memory device 132.

For example, the memory device 132 can be an EPROM. As is known in the art, when an EPROM is to be read, the voltage at an input to the EPROM can be alternately pulled high and low. The microprocessor 144 can accomplish this process through the selective operation of the switch 162. Specifically, when the read sequence of the ERPOM calls for the voltage on the appropriate EPROM pin to be pulled low, the microprocessor 144 can turn on the switch 162 by pulling the voltage at the output 164 high. Turning the switch 162 on can cause the voltage at the node 152 to be low.

Conversely, when the read sequence of the EPROM calls for the voltage at the appropriate EPROM pin to be pulled high, the microprocessor 144 can turn off the switch 162 by pulling the voltage at the output 164 low. Turning the switch 162 off can cause the voltage at the node 152 to be high. In this fashion, the memory device 132 can be manipulated to output its information. The microprocessor 144 can then read the memory device 132 via the A/D converter 160.

By reading the memory device 132, the microprocessor 144 can acquire information concerning the battery 112. In view of this information, the microprocessor 144 can take appropriate steps to ensure that the battery 112 is efficiently and properly charged. For example, the microprocessor 144 can transmit control signals to the current control circuit 146 to adjust the flow of current to the battery 112. In view of the foregoing, only a single contact on the battery 112 is needed for the battery charger 110 to read a value of the thermistor 130, e.g., the impedance of the thermistor 130, and to read the memory device 132.

Of course, it is understood that the memory device 132 is not limited to being an EPROM, as the memory device can be any other suitable component capable of storing information. Moreover, the memory device 132 is in no way limited to merely storing information about the status of the battery 112, as the memory device 132 can store any other suitable type of data.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A battery charging system, comprising:
a battery charger; and
a battery, said battery comprising a thermistor and a memory device, said thermistor and said memory device terminating in a single battery contact, wherein said thermistor produces an analog signal at said single battery contact and said memory device produces a digital signal at said single batter contact;
wherein said battery charger has a contact for receiving said battery contact;
wherein said battery charger selectively reads at least one of said memory device and a value of said thermistor through said battery charger contact.

2. The system according to claim 1, wherein said battery charger is at least one of a stand-alone charger and a host device.

3. The system according to claim 1, wherein said thermistor and said memory device are coupled in a parallel configuration.

4. The system according to claim 1, wherein said battery further comprises a first voltage shifting element for maintaining a predetermined minimum voltage for said memory device.

5. The system according to claim 1, wherein said memory device is an erasable programmable read only memory.

6. The system according to claim 1, wherein said battery charger comprises a second voltage shifting element and a microprocessor for selectively reading said memory device and said value of said thermistor.

7. The system according to claim 6, wherein said second voltage shifting element is a zener diode.

8. The system according to claim 6, wherein said battery charger further comprises a switch, wherein said microprocessor is programmed to selectively operate said switch.

9. The system according to claim 8, wherein said battery charger contact is coupled to said microprocessor through a first node and wherein said switch is coupled to said first node.

10. The system according to claim 9, wherein when said battery charger contact receives said battery contact, said microprocessor deactivates said switch to read said value of said thermistor.

11. The system according to claim 9, wherein when said battery charger contact receives said battery contact, said microprocessor selectively activates and deactivates said switch to read said memory device.

12. The system according to claim 9, wherein said microprocessor includes an analog-to-digital converter coupled to said first node and an output coupled to said switch.

13. The system according to claim 6, wherein said microprocessor includes a current control circuit for controlling the flow of current to said battery, said microprocessor being coupled to said current control circuit.

14. A battery, comprising:
a thermistor; and
a memory device, said thermistor and said memory device terminating in a single battery contact, wherein said thermistor produces an analog signal at said single battery contact and said memory device produces a digital signal at said single battery contact.

15. The battery according to claim 14, further comprising a voltage shifting element for maintaining a predetermined minimum voltage for said memory device.

16. The battery according to claim 15, wherein said thermistor, said voltage shifting element and said memory device are coupled in a parallel configuration.

17. A battery charger, comprising:
a contact; and
a microprocessor, wherein said microprocessor selectively roads both a memory device and a value of a thermistor through said contact, wherein the thermistor produces an analog signal at said contact and the memory device produces a digital signal at said contact.

18. The battery charger according to claim 17, further comprising a voltage shifting element coupled to said contact, wherein said microprocessor includes an analog-to-digital converter coupled to said voltage shifting element.

19. The battery charger according to claim 17, further comprising a switch, wherein said microprocessor is programmed to selectively operate said switch to permit said microprocessor to read at least one of said memory device and said value of said thermistor.

20. A method for charging a battery, comprising the steps of:
in a battery charger having a first contact, coupling a second contact to the first contact, wherein a thermistor and a memory device terminate in the second contact;
selectively producing at at least the second contact an analog signal from the thermistor and a digital signal from the memory device; and
selectively reading at least one of the memory device and a value of the thermistor through the first contact and the second contact.

21. The method according to claim 20, further comprising the step of shifting a voltage to maintain a predetermined minimum voltage for the memory device.

22. The method according to claim 20, farther comprising the step of selectively operating a switch to permit the execution of said reading step.
